(19) United States
(12) Patent Application Publication
(10) Pub. No.: US 2013/0314348 A1
(43) Pub. Date: Nov. 28, 2013

(54) ELECTRONIC DEVICE

(71) Applicants: Wei-Wen Luo, Taipei City (TW); Wing-Hang Calvin Ku, Taipei City (TW)

(72) Inventors: Wei-Wen Luo, Taipei City (TW); Wing-Hang Calvin Ku, Taipei City (TW)

(73) Assignee: ASUSTEK COMPUTER INC., Taipei City (TW)

(21) Appl. No.: 13/896,314

(22) Filed: May 16, 2013

Related U.S. Application Data
(60) Provisional application No. 61/651,561, filed on May 25, 2012.

(30) Foreign Application Priority Data
Mar. 21, 2013 (TW) 102110020

(51) Int. Cl. G09G 5/00

(52) U.S. Cl. CPC G09G 5/003
USPC 345/173; 345/1.1

(57) ABSTRACT

An electronic device including a lower body, an upper body, a first screen, a second screen and a detecting element is provided. The upper body is pivotally connected to the lower body and capable to rotate relatively. When the upper body rotates to make the detector detect that the upper body is at a closed position, the electronic device is switched to a first mode, the second screen disposed on an external surface of the upper body displays a first image. When the upper body rotates to make the detecting element detect that the upper body is at an opening position, the electronic device is switched to a second mode, and the first screen disposed on an inner surface of the upper body displays the first frame.

### CROSS-REFERENCE TO RELATED APPLICATION

This application claims the priority benefits of U.S. provisional application Ser. No. 61/651,561, filed on May 25, 2012 and Taiwan application serial no. 102110020, filed on Mar. 21, 2013. The entirety of each of the above-mentioned patent applications is hereby incorporated by reference herein and made a part of this specification.

### BACKGROUND OF THE INVENTION

### Field of the Invention

With the development of electronic technology, electronic devices such as a notebook computer (NB), a tablet computer and a smart phone are widely used in our daily life due to its convenience and practicability.

Moreover, the electronic device becomes more diversified. For example, the electronic device is integrated to a single body to improve the portability and the convenience. The electronic device such as the notebook computer is usually configured with a single screen to display. However, to add the function, a touch screen of a notebook computer may be capable of turning over via the improvement on the structure, and the notebook computer can be regarded as a tablet computer when the notebook computer is closed. However, although the notebook computer also can be used as a tablet computer, the mode switching is complex and not intuitive. Moreover, the electronic device only can be used for a single user, and the image on the screen cannot be shared by multiple users.

### BRIEF SUMMARY OF THE INVENTION

An electronic device is provided. The electronic device includes dual screens, and the screen to display the image is changed according to the position of the upper body of the electronic device.

The electronic device includes a lower body, an upper body, a first screen, a second screen and a detector. The upper body is pivotally connected to the lower body, and the upper body rotates between a closed position and an open position relative to the lower body. The upper body includes an inner surface and an external surface relative to the inner surface. The inner surface of the upper body faces the lower body. The first screen and the second screen are disposed at the inner surface and the external surface of the upper body respectively. The detector is used for detecting the relative location of the upper body and the lower body.

When the upper body rotates relative to the lower body and the detector detects that the upper body is at the closed position, the electronic device is switched to a first mode, and the second screen displays a first image. When the upper body rotates relative to the lower body and the detector detects that the upper body is at the open position, the electronic device is switched to a second mode, and the first screen displays the first image.

Based on above, when the upper body of the electronic device rotates relative to the lower body, the detector detects the position of the upper body and makes the electronic device be switched to a first mode or a second mode. When the upper body is at the first mode, the electronic device make the second screen display a first image. When the upper body is at the second mode, the electronic device make the first screen display the first image. Thus, the electronic device includes dual screens, and the screen for displaying the image is switched automatically according to the positions of the upper body of the electronic device.

### BRIEF DESCRIPTION OF THE DRAWINGS

FIG. 1 is a schematic diagram showing that the upper body of the electronic device is at a closed position.

FIG. 2 is a schematic diagram showing that the upper body of the electronic device at FIG. 1 is at the open position.

FIG. 3 is a schematic diagram showing that the upper body of the electronic device at FIG. 1 is at the closed position and the electronic device is at a first mode.

FIG. 4 is schematic diagram showing that the upper body of the electronic device at FIG. 2 is at the open position and the electronic device is at a second mode.

FIG. 5 is a schematic diagram showing that the upper body of the electronic device at FIG. 4 is at the open position and the electronic device is at a third mode.

FIG. 6 is a schematic diagram showing that the upper body of the electronic device in FIG. 4 is at the open position and the electronic device is at a fourth mode.

FIG. 7 is a schematic diagram showing that the electronic device in FIG. 1 switches among modes.

FIG. 8 is a schematic diagram showing the electronic device in FIG. 1 transmits the control signal.

### DETAILED DESCRIPTION OF THE EMBODIMENTS

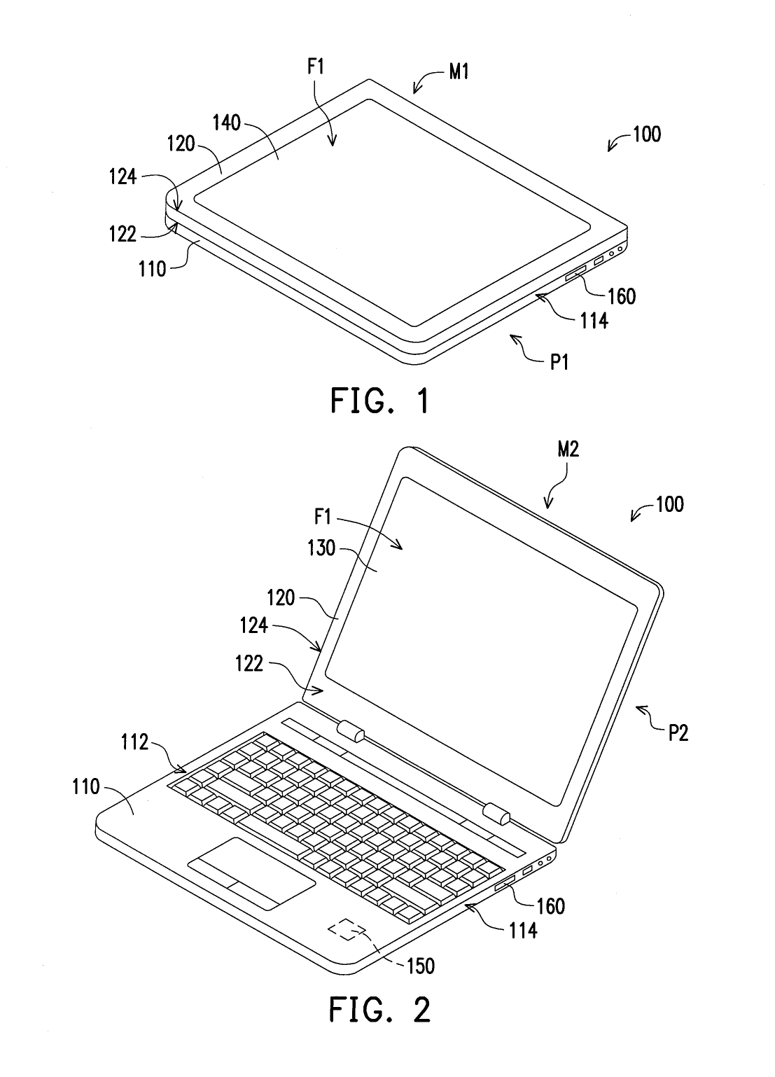

FIG. 1 is a schematic diagram showing that the upper body of the electronic device is at a closed position. FIG. 2 is a schematic diagram showing that the upper body of the electronic device in FIG. 1 is at an open position. Referring to FIG. 1 and FIG. 2, in this embodiment, the electronic device 100 includes a lower body 110, an upper body 120, a first screen 130, a second screen 140 and a detector 150.

The upper body 120 is pivotally connected to the lower body 110, and the upper body 120 rotates relative to the lower body 110 between the closed position P1 and the open position P2. The upper body 120 includes an inner surface 122 and an external surface 124 opposite to the inner surface 122, and the inner surface 122 of the upper body 120 faces the lower body 110. Thus, when the upper body 120 rotates to the closed position P1 relative to the lower body 110, the upper body 120 overlaps the lower body 110, and the inner surface 122 is hidden between the upper body 120 and the lower body 110. When the upper body 120 rotates to the open position P2 relative to the lower body 110, the inner surface 122 and the external surface 124 are exposed from the electronic device 100.

In this embodiment, the first screen 130 and the second screen 140 are disposed at the inner surface 122 and the external surface 124 of the upper body 120 respectively. Furthermore, the lower body 110 further includes an input module 112 such as a keyboard module or a touch pad module, the input module 112 is disposed at the lower body 110 to control the electronic device 100, the type and the setting of the input module are not limited herein. Thus, the electronic device 100 such as a notebook computer can be used as a tablet computer. The kind of the electronic device 100 is not limited.

Furthermore, the detector 150 may be disposed at the lower body 110, and it can detect the position of the upper body 120 relative to the lower body 110. The detector 150 may be a magnetic element to detect the position of the upper body 120 via the magnetism detecting. However, the detector 150 also can be disposed at the upper body 120, and the detector 150 can be other type of elements with the detecting function such as one or a composition of a capacitance sensor and a proximity sensor. The position and the type of the detector 150 are not limited herein.

In this embodiment, the detector 150 is disposed at the lower body 110. When the upper body 120 rotates relative to the lower body 110, the detector 150 is used to detect that the upper body 120 is at the closed position P1 or the open position P2. Thus, when the upper body 120 rotates relative to the lower body 110 and the detector 150 detects that the upper body 120 is at the closed position P1, the electronic device 100 is switched to a first mode M1 to make the second screen 140 display a first image F1, as shown in FIG. 1. When the upper body 120 rotates relative to the lower body 110 and the detector 150 detects that the upper body 120 is at the open position P2, the electronic device 100 is switched to a second mode M2 to make the first screen 130 display a first image F1, as shown in FIG. 2.

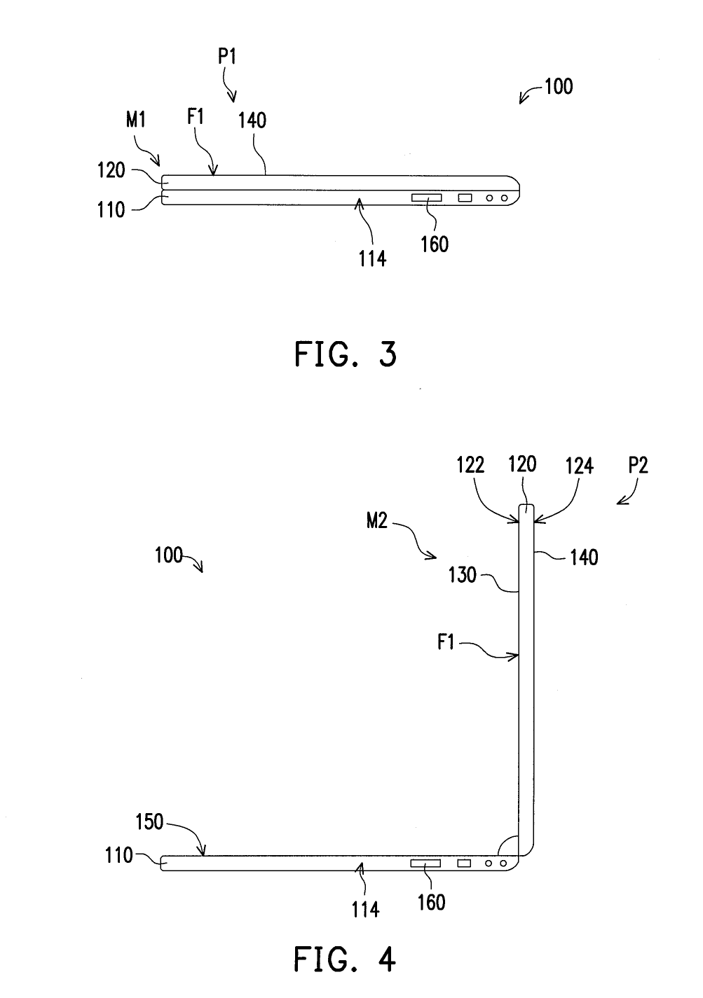

FIG. 3 is a schematic diagram showing that the upper body of the electronic device at FIG. 1 is at the closed position and the electronic device is at a first mode. FIG. 4 is schematic diagram showing that the upper body of the electronic device in FIG. 2 is at the open position and the electronic device is at a second mode. Referring to FIG. 1 to FIG. 4, in this embodiment, the first screen 130 and the second screen 140 is disposed at the inner surface 122 and the external surface 124 of the upper body 120 respectively. When the upper body 120 is at the closed position P1, the electronic device 100 is at the first mode M1, and the first mode M1 may be a tablet mode, that is, the second screen 140 displays a first image F1 to be used as a tablet computer, as shown in FIG. 1 and FIG. 3.

When the upper body 120 rotates from the closed position P1 to the open position P2 relative to the lower body 110, the detector 150 detects the distance between the upper body 120 and the lower body 110 or the rotation angle of the upper body 120 relative to the lower body 110 to determine the position of the upper body 120. When the detector 150 detects that the upper body 120 is at the open position P2, the electronic device 100 is switched from the first mode M1 to the second mode M2 automatically. The second mode M2 can be a notebook computer mode and the first screen 130 display a first image F1, the electronic device can be used as a notebook computer, as shown in FIG. 2 and FIG. 4.

Furthermore, when the electronic device 100 is at a first mode M1, since the first screen 130 is hidden between the lower body 110 and the upper body 120, the electronic device 100 makes the second screen 140 display the first image F1. When the electronic device 100 is at the second mode M2, the electronic device 100 changes to make the first screen 130 display the first image F1 to allow the user to operate the input module 112 at the lower body 110 when watching the first image F1 via the first screen 130.

In this embodiment, the electronic device 100 is switched between the first mode M1 and the second mode M2 to make the first image F1 displayed between the second screen 140 and the first screen 130. In other words, when the upper body 120 rotates from the closed position P1 relative to the lower body 110 and the detector 150 detects that the upper body 120 is at the open position P2, the first image F1 displayed by the second screen 140 is converted to be displayed on the first screen 130 when the upper body 120 rotates.

At the time, the second screen 140 does not display the first image F1, but the second screen 140 can display preset wallpaper or other images, and the image displayed on the second screen 140 can be changed according to the background color of the first image F1. Thus, when the upper body 120 rotates to the open position P2 or even in the process that the upper body 120 rotates to the open position P2, others except the user of the electronic device 100 cannot watch the first image F1 from the second screen 140 to protect the privacy of the users, and the appearance of the electronic device 100 is beautiful.

Similarly, when the upper body 120 rotates from the open position P2 relative to the lower body 110 and the detector 150 detects that the upper body 120 is at the closed position P1, the first image F1 displayed by the first screen 130 is changed to be displayed on the second screen 140. The electronic device 100 is changed between the first mode M1 and the second mode M2 according to the rotation of the upper body 120 relative to the lower body 110. The second screen 140 or the first screen 130 displays the same image according to the modes without interrupting the operation process of the electronic device 100 in switching the modes. Moreover, the size of the first screen 130 is the same as that of the second screen 140. Thus, whether the first screen 130 or the second screen 140 has the same effect in displaying the first image F1.

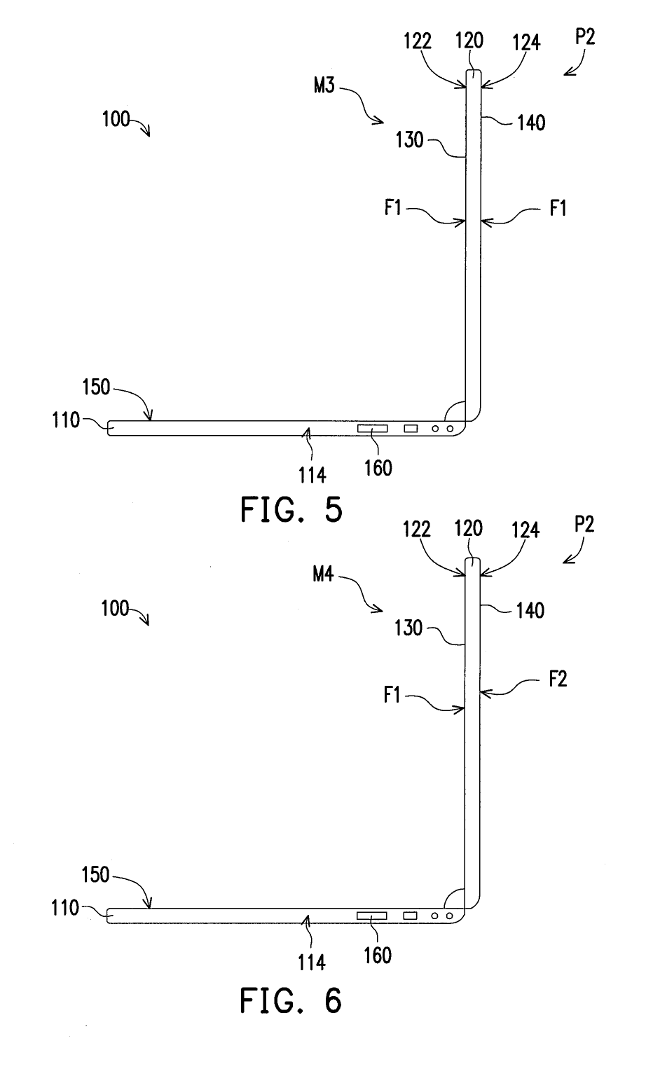

FIG. 5 is a schematic diagram showing that the upper body of the electronic device at FIG. 4 is at the open position and the electronic device is at a third mode. FIG. 6 is a schematic diagram showing that the upper body of the electronic device in FIG. 4 is at the open position and the electronic device is at a third mode. Referring to FIG. 5 and FIG. 6, in this embodiment, when the upper body 120 is at the open position P2, the electronic device 100 is switched to the third mode M3, the first screen 130 and the second screen 140 display the first image F1 simultaneously.

When the upper body 120 is at the open position P2, the electronic device 100 is switched to the fourth mode M4, the first screen 130 displays the first image F1, and the second screen 140 displays the second image F2 which is different from the first image F1. In this embodiment, the electronic device 100 further includes a trigger element 160, and the trigger element 160 is disposed at a side 114 of the lower body 110. The electronic device 100 is switched from the second mode M2 to the third mode M3 or the fourth mode M4 via the trigger element 160. In this embodiment, the trigger element 160 is a physical button, it also can be a specific signal inputted by the input module 112, which is not limited herein.

When the upper body 120 is at the open position P2 and the electronic device 100 is at the second mode M2, the electronic device 100 can be switched from the second mode M2 to the third mode M3 via the trigger element 160. Referring to FIG. 4 and FIG. 5, the third mode M3 can be a minor mode in which the first screen 130 and the second screen 140 displays the first image F1 simultaneously. At the moment, the electronic device 100 make both the first screen 130 and the second screen 140 display the first image F1, multi players can watch the same image such as the same film from two opposite directions (the direction facing the inner surface 122 and the external surface 124, respectively) via the first screen 130 and the second screen 140. Thus, it can add the function of the electronic device 100.

Furthermore, when the upper body 120 is at the open position P2 and the electronic device 100 is at the third mode M3, the electronic device 100 can be switched from the third mode M3 to the fourth mode M4 via the trigger element 160. Referring to FIG. 5 and FIG. 6, the fourth mode M4 is an extend mode, the first screen 130 still displays the first image F1, and the second screen 140 displays the second image F2 which is different from the first image F1. The electronic device 100 can make the first screen 130 and the second screen 140 display two different images such as the first image F1 and the second image F2 by software. Different users can watch the different images from two opposite directions (face the inner surface 122 and face the external surface 124) via the first screen 130 and the second screen 140. For example, the first image F1 is for editing files, the user can edit the file by the input module 112. The second image F2 is for playing the video, thus different users can has different operation at the same time. The electronic device 100 has diverse functions.

In this embodiment, the first screen 130 and the second screen 140 may be touch display screens, which is not limited herein. When the electronic device 100 is switched to the first mode M1, the second mode M2, the third mode M3 or the fourth mode M4, the first screen 130 and/or the second screen 140 display the first image F1 and/or the second image F2, and the user can operate the electronic device 100 by touching the first screen 130 and/or the second screen 140.

When the electronic device 100 is at the first mode M1, the second screen 140 displays the first image F1 and can be regarded as an input interface, and the electronic device can be operated by touching the second screen 140. When the electronic device 100 is at the second mode M2, the first screen 130 displays the first image F1, and the electronic device 100 takes the input module 112 (as shown in FIG. 2) and the first screen 130 as the input interface, for example, the user operates the electronic device 100 by using the keyboard or touching the first screen 130.

Furthermore, when the electronic device 100 is at the third mode M3 or the fourth mode M4, the first screen 130 displays the first image F1, the second screen 140 displays the first image F1 or the second image F2 correspondingly, and the electronic device 100 takes the input module 112 (as shown in FIG. 2), the first screen 130 and the second screen 140 as the input interfaces. When the electronic device 100 takes the first screen 130 and the second screen 140 as the input interface, the first screen 130 and the second screen 140 is touched to operate the electronic device. The electronic device 100 can simultaneously receive the signal inputted by the first screen 130 and the second screen 140, and thus the electronic device 100 has the two-way interactive function by the first screen 130 and the second screen 140 when it is at the third mode M3 and the fourth mode M4.

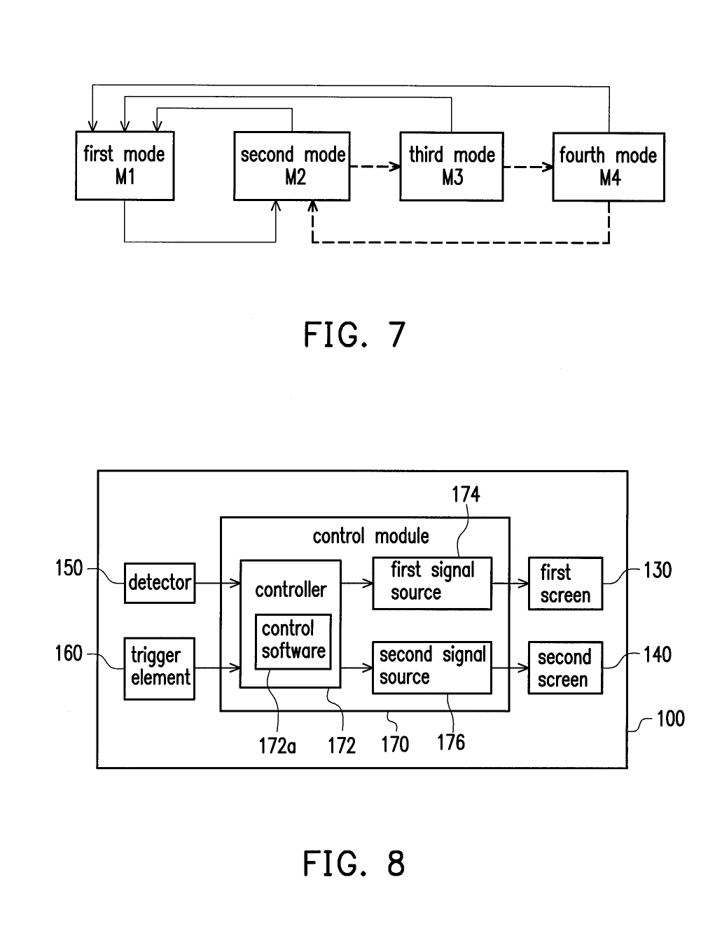

FIG. 7 is a schematic diagram showing that the electronic device in FIG. 1 switches the mode. FIG. 7 shows the switching sequence and the switching method among the first mode M1, the second mode M2, the third mode M3 and the fourth mode M4 of the electronic device 100. A thin solid line arrow represents that the two modes are switched automatically by the rotation of the upper body 120 relative to the lower body 110. A thick broken line represents that the two modes are switched by the trigger element 160. The switching sequence shows in FIG. 7 is just an embodiment, and the invention is not limited thereto.

Referring to FIG. 7, in this embodiment, the electronic device 100 can be switched automatically between the first mode M1 and the second mode M2 by rotating the upper body 120 relative to the lower body 110. When the electronic device 100 is at the second mode M2 and the upper body 120 is at the open position P2 simultaneously, the electronic device 100 can be switched from the second mode M2 to the third mode M3 via the trigger element 160, and then it can be switched from the third mode M3 to the fourth mode M4 via the trigger element 160, and then switched from the fourth mode M4 back to the second mode M2 via the trigger element 160, as shown in the thick broken line arrow.

Moreover, when the electronic device 100 is at the third mode M3 or the fourth mode M4, the electronic device 100 is switched from the third mode M3 or the fourth mode M4 to the first mode M1 by rotating the upper body 120 to the closed position P1 (as shown in FIG. 5 to FIG. 3, or FIG. 6 to FIG. 3, and the thin solid line arrows shown in FIG. 7). When the upper body 120 is rotated to the open position P2 again, the electronic device 100 is switched from the first mode M1 to the second mode M2 automatically. The mode of the electronic device 100 can be easily switched.

However, the switching sequence of the electronic device 100 via the trigger element 160 is not limited to the sequence from the second mode M2 to the third mode M3 and then to the fourth mode M4. The switching sequence of the electronic device 100 via the trigger element 160 also may be from the second mode M2 to the fourth mode M4, and then to the third mode M3. The second mode M2 can be directly switched to the third mode M3 or the fourth mode M4 by driving the trigger element 160 in different modes such as at different driving time, and the third mode M3 or the fourth mode M4 is switched back to the second mode M2 via the trigger element 160 drove in the above mode. The switching sequence of the electronic device 100 among the second mode M2, the third mode M3 and the fourth mode M4 is not limited herein.

FIG. 8 is a schematic diagram showing the electronic device in FIG. 1 transmits the control signal. Referring to FIG. 7 and FIG. 8, the electronic device 100 further includes a control module 170. The control module 170 is connected to the detector 150 and the trigger element 160 to receive the control signal outputted by the detector 150 and the trigger element 160, and the control module 170 detects the mode corresponding to the control signal to make the electronic device 100 switched to the first mode M1, the second mode M2, the third mode M3 or the fourth mode M4.

The control module 170 includes a controller 172, a first signal source 174 and a second signal source 176. The controller 172 has control software 172a. The controller 172 is connected to the detector 150 and the trigger element 160 to receive the control signal and determines the mode corresponding to the control signal via the control software 172a. The controller 172 is connected to a first signal source 174 and a second signal source 176 to transmit the control signal to the first signal source 174 and the second signal source 176.

The first signal source 174 and the second signal source 176 are connected to the first screen 130 and the second screen 140 respectively. After the control software 172a determines the mode corresponding to the control signal, the controller 172 transmits the control signal to the first signal source 174 to make the first signal source 174 drive or not drive the first screen 130 to display the first image F1. Simultaneously, the controller 172 transmits the control signal to the second signal source 176 to make the second signal source 176 drive or not drive the second screen 140 to display the first image F1 or the second image F2.

When the detector 150 detects the upper body 120 rotates from the closed position P1 to the open position P2, the detector 150 transmits the control signal to the controller 172 and detects that the electronic device 100 should be switched to the second mode M2 via the control software 172a. The controller 172 transmits the control signal corresponding to the second mode M2 to the first signal source 174 and the second signal source 176. The first signal source 174 drive the first screen 130 to display the first image F1, the second signal source 176 drives the second screen 140 to display the preset image such as the wallpaper to make the electronic device 100 at the second mode M2.

When the electronic device 100 is at the second mode M2 and the trigger element 160 is driven, the trigger element 160 transmits the control signal to the controller 172 and the control software 172a determines that the electronic device 100 should be switched to the third mode M3. Thus, the controller 172 transmits the control signal corresponding to the third mode M3 to the first signal source 174 and the second signal source 176. At the moment, the first signal source 174 drives the first screen 130 to display the first image F1, the second signal source 176 drives the second screen 140 to display the first image F1, and the electronic device 100 is at the third mode M3. Consequently, the electronic device 100 includes dual screens, the screen for displaying the image can be switched automatically by rotating the upper body 120 of the electronic device 100, and the dual screens can display same or different screens by driving the trigger element 160. Thus, the electronic device 100 can have diverse functions.

In sum, when the upper body of the electronic device rotates relative to the lower body, the detector detects the position of the upper body to make the electronic device automatically switched to a first mode or a second mode. When the upper body is at the first mode, the electronic device make the second screen display a first image. When the upper body is at the second mode, the electronic device make the first screen display the first image. Furthermore, the electronic device can be switched from the second mode to the third mode or the fourth mode via the trigger element to make the dual screens display same or different images. Thus, the electronic device includes dual screens, the screen for displaying the image can be switched automatically by rotating the upper body, and the electronic device has diverse functions.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An electronic device, comprising:
a lower body;
an upper body pivotally connected to the lower body, wherein the upper body rotates between a closed position and an open position relative to the lower body, the upper body includes an inner surface and an external surface relative to the inner surface, and the inner surface of the upper body faces the lower body;
a first screen and a second screen disposed at the inner surface and the external surface of the upper body, respectively; and
a detector for detecting the position of the upper body relative to the lower body, wherein when the upper body rotates relative to the lower body and the detector detects that the upper body is at the closed position, the electronic device is switched to a first mode to make the second screen display a first image, when the upper body rotates relative to the lower body and the detector detects that the upper body is at the open position, the electronic device is switched to the second mode to make the first screen display the first image.

2. The electronic device according to claim 1, wherein the size of the first screen is the same as the size of the second screen.

3. The electronic device according to claim 1, wherein when the upper body is at the open position, the electronic device is switched to a third mode, and the first screen and the second screen displays the first image simultaneously.

4. The electronic device according to claim 3, wherein the upper body is at the open position, the electronic device is switched to a fourth mode, the first screen displays the first image, and the second screen displays a second image which is different from the first image.

5. The electronic device according to claim 4, wherein the first screen and the second screen are touch screens, and the electronic device can be operated by operating the first screen or the second screen.

6. The electronic device according to claim 4, further including a trigger element, wherein the trigger element is disposed at aside of the lower body, the electronic device is switched from the second mode to the third mode or the fourth mode by driving the trigger element.

7. The electronic device according to claim 6 further including a control module, wherein the control module is connected to the detector and the trigger element to receive a control signal outputted by the detector or the trigger element, and the electronic device is switched to the first mode, the second mode, the third mode or the fourth mode by determining the mode corresponding to the control signal.

8. The electronic device according to claim 7, wherein the control module includes a controller, the controller includes a control software, the controller is connected to the detector and the trigger element to receive the control signal, and the mode corresponding to the control signal is determined via the control software.

9. The electronic device according to claim 8, wherein the control module further includes a first signal source and a second signal source connected to the first screen and the second screen respectively, the controller is connected to the first signal source and the second signal source, the controller transmits the control signal to the first signal source and the second signal source after the control software determines the mode corresponding to the control signal.

10. The electronic device according to claim 1, wherein the detector is one or a combination of a magnetic element, a capacitance sensor and a proximity sensor.

11. The electronic device according to claim 1, wherein the detector is disposed at the upper body or the lower body.
